(19) United States
(12) Patent Application Publication
(10) Pub. No.: US 2014/0085942 A1
(43) Pub. Date: Mar. 27, 2014

(54) SHUNT REGULATOR HAVING PROTECTION FUNCTION AND POWER SUPPLY DEVICE HAVING THE SAME

(71) Applicant: SAMSUNG ELECTRO-MECHANICS CO., LTD., Suwon (KR)

(72) Inventors: Jung Chul GONG, Suwon (KR); Jong Rok KIM, Suwon (KR); Hwan CHO, Suwon (KR)

(73) Assignee: SAMSUNG ELECTRO-MECHANICS CO., LTD., Suwon (KR)

(21) Appl. No.: 13/837,428

(22) Filed: Mar. 15, 2013

(30) Foreign Application Priority Data
Sep. 21, 2012 (KR) 10-2012-0105297

(51) Int. Cl. H02M 3/315

(52) U.S. Cl. CPC H02M 3/3155
USPC 363/21.15

(57) ABSTRACT

There are provided a shunt regulator having a protection function to detect an abnormal state, and a power supply device having the same. The shunt regulator of a power supply device in which a primary side and a secondary side have grounds having different electrical characteristics and are electrically insulated from one another, and power switched from the primary side is induced to the secondary side so as to be output, includes: a comparator positioned on the secondary side and comparing a voltage output from the power supply device with a preset reference voltage; and a first switch performing a control to stop supply of driving power required for a power switching operation of the primary side according to a comparison result from the comparator.

### CROSS-REFERENCE TO RELATED APPLICATIONS

This application claims the priority of Korean Patent Application No. 10-2012-0105297 filed on Sep. 21, 2012, in the Korean Intellectual Property Office, the disclosure of which is incorporated herein by reference.

### BACKGROUND OF THE INVENTION

1. Field of the Invention

The present invention relates to a shunt regulator having a protection function capable of stopping a power supply operation upon the occurrence of an abnormal state, and a power supply device having the same.

2. Description of the Related Art

In general, in order to drive an electronic device, a power supply device supplying driving power required for operation of the electronic device is essential.

A power supply device generally converts commercial alternating current (AC) power into direct current (DC) driving power and supplies the same to an electronic device, and in this case, a power conversion circuit for directly converting commercial AC power into driving power may largely employ a switching mode power supply (SMPS) scheme.

A power conversion circuit according to the SMPS scheme stabilizes power induced to a primary side that switches power and a secondary side insulated from the primary side and outputs the same. In order to control primary side power switching, a shunt regulator may be employed in the secondary side.

The shunt regulator is a regulator having a current shunt to maintain a predetermined output voltage.

Namely, the foregoing shunt regulator compares an output voltage and a reference voltage and feeds back a signal corresponding to the comparison result to the primary side to control primary side switching.

Meanwhile, when various abnormal states such as an overvoltage state, an overcurrent state, and the like, occur, the power conversion circuit according to the SMPS scheme may employ an overvoltage protection circuit as disclosed in the related art document presented below, but in this case, an additional circuit is required to protect the power conversion circuit against an abnormal state, which increases fabrication costs.

### RELATED ART DOCUMENT

(Patent Document 1) Korean Patent Laid-Open Publication No. 10-2005-0035376

### SUMMARY OF THE INVENTION

An aspect of the present invention provides a shunt regulator having a protection function for detecting an abnormal state, and a power supply device having the same.

According to an aspect of the present invention, there is provided a shunt regulator of a power supply device in which a primary side and a secondary side have grounds having different electrical characteristics and electrically insulated from one another, and power switched from the primary side is induced to the secondary side so as to be output, the shunt regulator including: a comparator positioned on the secondary side and comparing a voltage output from the power supply device with a preset reference voltage; and a first switch performing a control to stop supply of driving power required for a power switching operation of the primary side according to a comparison result from the comparator.

The shunt regulator may further include a protection unit requesting a cutoff of the supply of the driving power required for the power switching operation of the primary side when a preset abnormal state occurs.

The shunt regulator may further include a second switch performing a control to stop the supply of the driving power required for the power switching operation of the primary side under control of the protection unit.

According to another aspect of the present invention, there is provided a power supply device including: a power supply unit including a primary side and a secondary side having grounds having different electrical characteristics and electrically insulated from one another, and inducing power switched from the primary side to the secondary side so as to be output; and a shunt regulator controlling supply of driving power required for a power switching operation of the primary side of the power supply unit according to a comparison result obtained by comparing a voltage output from the power supply unit with a preset reference voltage.

The shunt regulator may include a comparator comparing the voltage output from the power supply unit with the reference voltage; and a first switch performing a control to stop the supply of the driving power required for the power switching operation of the primary side according to the comparison result from the comparator.

The shunt regulator may further include a protection unit requesting a cutoff of the supply of the driving power required for the power switching operation of the primary side when a preset abnormal state occurs.

The shunt regulator may further include a second switch performing a control to stop the supply of the driving power required for the power switching operation of the primary side under control of the protection unit.

The power supply unit may include: a switching unit switching input power of the primary side to allow the input power to be induced to the secondary side; a control unit positioned on the primary side to receive the driving power, and controlling power switching of the switching unit according to a feedback signal from the shunt regulator; an output unit positioned on the secondary side to stabilize the power from the switching unit; a transfer unit transferring the feedback signal from the shunt regulator of the secondary side to the primary side; and a driving power supply unit positioned on the primary side and stopping the supply of the driving power, generated according to the power switching of the switching unit, to the control unit according to the feedback signal transferred from the transfer unit.

The switching unit may include: a power switch switching the input power under control of the control unit; and a transformer having a primary winding formed on the primary side to receive power switched by the power switch, a secondary winding formed on the secondary side and electromagnetically coupled to the primary winding to receive power induced thereto according to a winding ratio, and an auxiliary winding formed on the primary side and electromagnetically coupled to the primary winding to receive power induced thereto according to a winding ratio, and transferring the received power to the driving power supply unit.

The transfer unit may be a photocoupler having one side and the other side formed on the primary side and the secondary side, respectively. The other side of the photocoupler may convert a feedback signal from the shunt regulator into an optical signal and transfer the converted optical signal to one side thereof, and one side of the photocoupler may convert a feedback signal from the other side thereof into an electrical signal and transfer the converted electrical signal to the driving power supply unit.

The driving power supply unit may include a driving power switch switched off according to the feedback signal from the other side of the photocoupler to thereby cut off the supply of the driving power to the control unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic circuit diagram of a power supply device according to an embodiment of the present invention; and

FIG. 2 is a graph showing voltages and current waveforms of major parts of the power supply device according to an embodiment of the present invention.

### DETAILED DESCRIPTION OF THE EMBODIMENTS

Hereinafter, embodiments of the present invention will be described in detail with reference to the accompanying drawings so that they can be easily practiced by those skilled in the art to which the present invention pertains.

The invention may, however, be embodied in many different forms and should not be construed as being limited to the embodiments set forth herein. Rather, these embodiments are provided so that this disclosure will be thorough and complete, and will fully convey the scope of the invention to those skilled in the art. Moreover, detailed descriptions related to well-known functions or configurations will be ruled out in order not to unnecessarily obscure subject matters of the present invention.

In addition, like or similar reference numerals denote parts performing similar functions and actions throughout the drawings.

Unless explicitly described to the contrary, the word “comprise” and variations such as “comprises” or “comprising,” will be understood to imply the inclusion of stated elements but not the exclusion of any other elements.

Embodiments of the present invention will now be described in detail with reference to the accompanying drawings.

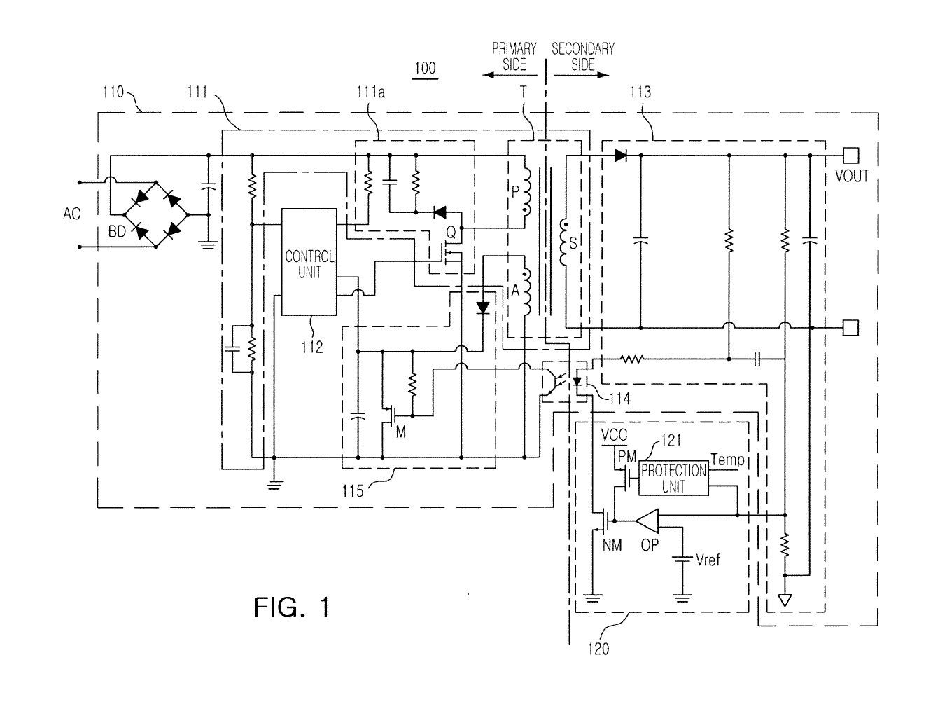

FIG. 1 is a schematic circuit diagram of a power supply device according to an embodiment of the present invention.

Referring to FIG. 1, a power supply device 100 according to an embodiment of the present invention may include a power supply unit 110 and a shunt regulator 120.

The power supply unit 110 may include a switching unit 111, a control unit 112, an output unit 113, a transfer unit 114, and a driving power supply unit 115.

The switching unit 111 may include a switching circuit 111a and a transformer T.

The switching circuit 111a may switch input power, and to this end, the switching circuit 111a may include a power switch Q.

The input power may be power obtained by rectifying AC power, and to this end, a bridge diode (BD) for half-wave rectifying or full-wave rectifying AC power may be connected to a front stage of the switching unit 111.

The power switch Q is switched on or off under the control of the control unit 112 to apply switched power to the transformer T, and extra power generated as the power switch Q is switched on or off may be consumed by a snubber circuit including a resistor, a capacitor, a diode, and the like.

The transformer T may include a primary winding P, a secondary winding S, and an auxiliary winding A.

The primary winding P may receive power switched by the power switch Q. The secondary winding S may be electromagnetically coupled to the primary winding P to have a preset winding ratio, and the switched power input to the primary winding P may be induced to the secondary winding S according to the winding radio.

The auxiliary winding A may be electromagnetically coupled to the primary winding P to have a preset winding ratio, and the switched power input to the primary winding P may be induced to the auxiliary winding A according to the winding ratio.

The power induced to the secondary winding S may be transferred to the output unit 113, and the power induced to the auxiliary winding A may be transferred to the driving power supply unit 115.

The output unit 113 may include a diode, a resistor, a capacitor, and the like, to stabilize the power from the secondary winding S and output the stabilized power.

The transfer unit 114 may transfer a feedback signal from the shunt regulator 120 to the driving power supply unit 115.

To this end, the transfer unit 114 may be a photo coupler of which one side and the other side are insulated.

The other side of the photocoupler may be connected to the shunt regulator 120, and one side of the photocoupler may transfer a feedback signal from the other side to the driving power supply unit 115.

An optical signal may be transmitted between one side and the other side of the photocoupler for insulation, and a current flowing in the other side of the photocoupler may be converted into an optical signal so as to be transferred to one side of the photocoupler, and upon receiving the optical signal, one side of the photocoupler may convert the received optical signal into an electrical signal and transfer the converted electrical signal to the driving power supply unit 115.

Namely, the feedback signal from the shunt regulator 120 may be transferred to the driving power supply unit 115 insulated with the shunt regulator 120 through the transfer unit 114.

The driving power supply unit 115 transfers the power induced from the auxiliary winding A to the control unit 112, and upon receiving driving power from the driving power supply unit 115, the control unit 112 may perform a switching control operation. To this end, the driving power supply unit 115 may include circuits such as a resistor, a capacitor, and the like, and a driving power switch M.

The circuits such as the resistor, the capacitor, and the like, may stabilize power induced from the auxiliary winding A or may stabilize driving power supplied to the control unit 112.

Upon receiving a feedback signal from one side of the transfer unit 114, a driving power switch M may perform a switching ON/OFF operation.

Namely, the driving power switch M may be configured as a PMOS transistor, and turned on when a low level signal is input to a gate thereof and turned off when a high level signal is input to the gate.

Accordingly, when the feedback signal from one side of the transfer unit 114 is a low level signal, the driving power switch M may be turned on to cut off the driving power supplied to the control unit 112.

As described above, the control unit 112 may perform a switching control operation upon receiving driving power, and when the supply of driving power is cut off, the control unit 112 may control the power switch Q to stop the switching operation.

The shunt regulator 120 may include a protection unit 121, first and second switches NM and PM, and a comparator OP.

The comparator OP receives a divided voltage of an output voltage VOUT according to a preset resistance ratio, compares the received voltage with a preset reference voltage Vref, and supplies the comparison result to the first switch NM. Upon receiving the comparison result by a gate thereof, the first switch NM, formed as an NMOS transistor, may transfer a feedback signal for controlling continuation or cutoff of supply of the driving power supplied to the control unit 112, to the other side of the transfer unit 114.

Thus, when a voltage level of the output voltage VOUT corresponds to an over voltage, the first switch NM may transfer a feedback signal for requesting cutoff of the driving power supplied to the control unit 112, to the other side of the transfer unit 114.

In addition, the protection unit 121 may receive a detected temperature Temp, and when a level of the detected temperature Temp exceeds a temperature level range corresponding to a voltage level of the output voltage VOUT, the protection unit 121 may determine an abnormal state, and provide a protection signal. Here, a place in which a temperature is detected may be arbitrarily set, and largely, a temperature may be detected from a major element, such as a switching element, a transformer, or the like, required for power supply.

The second switch PM, formed as a PMOS transistor, may receive the protection signal by a gate thereof from the protection unit 121, and may perform a turn-on/turn-off operation according to a signal level of the protection signal to form a transmission path of operating power VCC.

Namely, when a low level signal is input to the gate of the second switch PM, the second switch PM is turned on and the operating power VCC is applied to the gate of the first switch NM, and when a high level signal is input to the gate of the second switch PM, the second switch PM is turned off and the operating power VCC is not applied to the gate of the first switch NM.

Accordingly, when a level of the detected temperature Temp is outside of the temperature level range corresponding to the voltage level of the output voltage VOUT, the protection unit 121 may turn on the second switch PM to allow the operating power VCC to be applied to the first switch NM, and the first switch NM may be turned on to transfer a feedback signal for requesting cutoff of the driving power supplied to the control unit 112, to the other side of the transfer unit 114.

The transferring of the feedback signal for requesting cutoff of the driving power supplied to the control unit 112, to the other side of the transfer unit 114 will be described in more detail. When the first switch NM is turned on, a path is formed between the other side of the transfer unit 114 and a ground, so a level of a voltage applied to the other side of the transfer unit 114 is lowered, and a corresponding signal is transferred to one side of the insulated transfer unit 114, so a low level signal is applied to the driving power switch M, and the driving power switch M is turned on to connect a path along which power induced to the auxiliary winding A is transferred to the control unit 112 to a ground to thus cut off supply of driving power, and accordingly, the control unit 112 may control the power switch Q to stop a power switching operation.

Meanwhile, the power supply device 100 according to an embodiment of the present invention may have a primary side and a secondary side whose grounds have different electrical characteristics and which are electrically insulated from one another.

As illustrated, the switching circuit 111a of the switching unit 111, the primary winding P and the auxiliary winding A of the transformer T, the control unit 112, the other side of the transfer unit 114, and the driving power supply unit 115 may be formed on the primary side.

Meanwhile, the secondary winding S of the transformer T, the output unit 113, one side of the transfer unit 114, and the shunt regulator 120 may be formed on the secondary side.

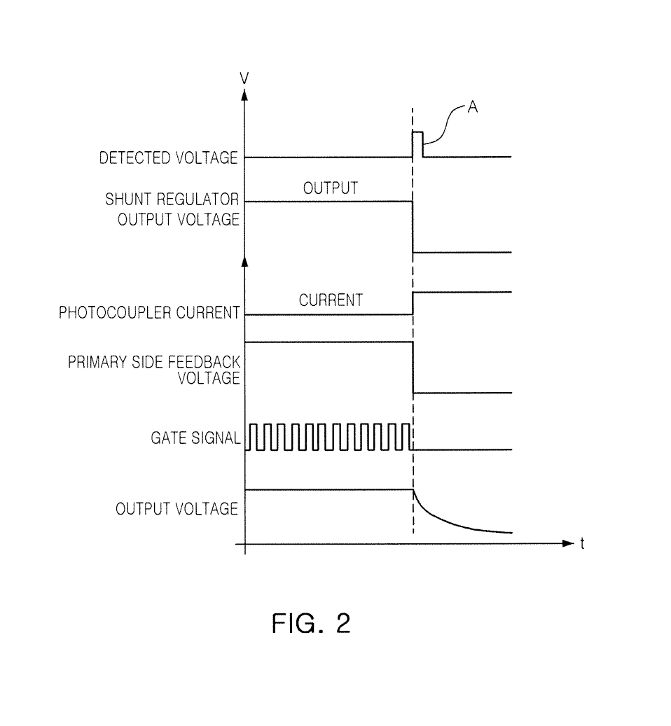

FIG. 2 is a graph showing voltages and current waveforms of major parts of the power supply device according to an embodiment of the present invention.

Referring to FIGS. 1 and 2, when an abnormal state is detected, the protection unit 121 outputs a high level detection voltage, and accordingly, the second switch PM and the first switch NM are sequentially turned on, and thus, an output voltage of the shunt regulator 120 is dropped to have a low level.

A current flowing in the transfer unit 114 configured as a photocoupler is increased to have a high level, and accordingly, a feedback voltage applied to the primary side is increased to have a high level to turn on the driving power switch M.

Thereafter, the supply of the driving power applied to the control unit 112 is cut off , and thus, a gate signal applied to the power switch Q from the control unit 112 is maintained at a low level and a voltage level of the output voltage VOUT is lowered.

As described above, according to embodiments of the present invention, in the occurrence of an abnormal state such as an overvoltage state, a high temperature state, and the like, the shunt regulator performs a protection function by cutting off the supply of driving power required for the switching operation of the primary side and stopping the switching operation, whereby fabrication costs can be reduced by omitting a separate protection circuit and a stable power supply operation can be performed.

As set forth above, according to the embodiments of the present invention, since the shunt regulator provides a protection function of detecting an abnormal state, an extra protection circuit is not required, and thus, the fabrication costs can be reduced.

While the present invention has been shown and described in connection with the embodiments, it will be apparent to those skilled in the art that modifications and variations can be made without departing from the spirit and scope of the invention as defined by the appended claims.

What is claimed is:

1. A shunt regulator of a power supply device in which a primary side and a secondary side have grounds having different electrical characteristics and are electrically insulated from one another, and power switched from the primary side is induced to the secondary side so as to be output, the shunt regulator comprising:
a comparator positioned on the secondary side and comparing a voltage output from the power supply device with a preset reference voltage; and
a first switch performing a control to stop supply of driving power required for a power switching operation of the primary side according to a comparison result from the comparator.

2. The shunt regulator of claim 1, further comprising a protection unit requesting a cutoff of the supply of the driving power required for the power switching operation of the primary side when a preset abnormal state occurs.

3. The shunt regulator of claim 2, further comprising a second switch performing a control to stop the supply of the driving power required for the power switching operation of the primary side under control of the protection unit.

4. A power supply device comprising:
a power supply unit including a primary side and a secondary side having grounds having different electrical characteristics and electrically insulated from one another, and inducing power switched from the primary side to the secondary side so as to be output; and
a shunt regulator controlling supply of driving power required for a power switching operation of the primary side of the power supply unit according to a comparison result obtained by comparing a voltage output from the power supply unit with a preset reference voltage.

5. The power supply device of claim 4, wherein the shunt regulator includes:
a comparator comparing the voltage output from the power supply unit with the reference voltage; and
a first switch performing a control to stop the supply of the driving power required for the power switching operation of the primary side according to the comparison result from the comparator.

6. The power supply device of claim 5, wherein the shunt regulator further includes a protection unit requesting a cutoff of the supply of the driving power required for the power switching operation of the primary side when a preset abnormal state occurs.

7. The power supply device of claim 6, wherein the shunt regulator further includes a second switch performing a control to stop the supply of the driving power required for the power switching operation of the primary side under control of the protection unit.

8. The power supply device of claim 7, wherein the power supply unit includes:
a switching unit switching input power of the primary side to allow the input power to be induced to the secondary side;
a control unit positioned on the primary side to receive the driving power, and controlling power switching of the switching unit according to a feedback signal from the shunt regulator;
an output unit positioned on the secondary side to stabilize the power from the switching unit;
a transfer unit transferring the feedback signal from the shunt regulator of the secondary side to the primary side; and
a driving power supply unit positioned on the primary side and stopping the supply of the driving power, generated according to the power switching of the switching unit, to the control unit according to the feedback signal transferred from the transfer unit.

9. The power supply device of claim 8, wherein the switching unit includes:
a power switch switching the input power under control of the control unit; and
a transformer having a primary winding formed on the primary side to receive power switched by the power switch, a secondary winding formed on the secondary side and electromagnetically coupled to the primary winding to receive power induced thereto according to a winding ratio, and an auxiliary winding formed on the primary side and electromagnetically coupled to the primary winding to receive power induced thereto according to a winding ratio, and transferring the received power to the driving power supply unit.

10. The power supply device of claim 8, wherein the transfer unit is a photocoupler having one side and the other side formed on the primary side and the secondary side, respectively,
the other side of the photocoupler converts a feedback signal from the shunt regulator into an optical signal and transferring the converted optical signal to one side thereof, and
one side of the photocoupler converts a feedback signal from the other side thereof into an electrical signal and transferring the converted electrical signal to the driving power supply unit.

11. The power supply device of claim 10, wherein the driving power supply unit includes a driving power switch switched off according to the feedback signal from the other side of the photocoupler to thereby cut off the supply of the driving power to the control unit.
